(19) United States
(12) Patent Application Publication
(10) Pub. No.: US 2007/0033422 A1
(43) Pub. Date: Feb. 8, 2007

(54) Method and device for processing sound file

(76) Inventor: In-Whan Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/497,941

(22) Filed: Aug. 1, 2006

(30) Foreign Application Priority Data
Aug. 2, 2005 (KR) 10-2005-0070586

(51) Int. Cl. G06F 12/14

(52) U.S. Cl. 713/193

(57) ABSTRACT

A system and a method of combining authentication information with a sound file are disclosed. In one embodiment, the sound file is combined with an authentication code such that the authentication code is located outside the audio frequency, which is not audible to human ear. A sound file playback device receives the sound file and extracts the authentication code through a frequency analysis method, and the sound file can be played back only if the authentication code matches a previously stored authentication code. According to one embodiment of the present invention, illegal circulation of the sound file can be prevented, preventing unauthorized copying and posting of the sound file, while enabling insertion and extraction without affecting the sound quality.

### BACKGROUND OF THE INVENTION

1. Field of the Invention

The present invention relates to protection of a sound file, more specifically to a device and a method for combining authentication information with a sound file so that the sound file is played back only if the authentication information matches another authentication information stored in a playback device.

2. Description of the Related Technology

MP3 players have become one of the most popular electronic devices. Their popularity brought the advent of a variety of types, including a necklace type and an earring type as well as a mobile phone type. The types of digital sound source that can be played in an MP3 player are also reaching an unprecedented number.

However, protecting digital sound files has become a challenge because the digital sound can be easily copied by a computing device and distributed through the Internet. To combat this problem, there has been several efforts, including changing the extension of the digital sound file or differentiating the format such that the digital sound can be played by the authenticated user or player.

Although the format of the digital sound is differentiated, sharing the memory among the same players will allow the sound file to be used by unauthenticated users. To prevent this unauthorized use, a method and device for processing the sound file, such that the sound file can be played back only in authenticated players, is needed.

The conventional methods include low bit coding, echo hiding and spread spectrum. In the low bit coding method, the sound file is inserted with a watermark by matching the least significant bit (LSB) of each sampling point of a binary string corresponding to the watermark. This method is fragile to signal processes such as resampling, compressing, noise, cropping, analog-to-digital conversion and digital-to-analog conversion. In the echo hiding method, the watermark is inserted in the echo component. However, the echo is inevitably audible to human ear. In the spread spectrum method, the watermark information is spread through as wide a spectrum as possible. This method is not very practical for sound signals that are delivered through a speaker having a narrow frequency spectrum.

### SUMMARY OF CERTAIN INVENTIVE ASPECTS

One aspect of the present invention provides a sound file server and a sound file playback device that can include authentication information in a sound file such that only an authenticated user and an authenticated playback device can play back the sound file.

Another aspect of the present invention provides a sound file server, a sound file playback device and a method thereof that can prevent illegal copying and posting of a sound file by preventing illegal distribution of the sound file.

Another aspect of the present invention provides a method, and a device using the method, for inserting and extracting real time authentication information without affecting the sound quality.

Another aspect of the present invention provides a method of inserting and extracting authentication information and a device using this method that can process the insertion/extraction operation of the authentication information real time and can be applied in a portable device such as an MP3 player.

Another aspect of the present invention provides a method, and a device using the method, for inserting authentication information using a frequency range that is not audible to human ear.

Another aspect of the present invention provides a sound file server providing a sound file. The sound file is requested by a sound file playback device with registered authentication information, and is capable of being played back in the sound file playback device. The sound file server can comprise: a sound source storing unit, storing a plurality of sound files; an authentication information registration unit, registering authentication information of the sound file playback device; a sound file combining unit, generating a combined sound file by searching the sound source storing unit for the requested sound file, including the authentication information in a predetermined combined frequency, and then combining the authentication information with the sound file; and a communication unit, receiving a request for the sound file from the sound file playback device and sending the combined sound file to the sound file playback device.

The authentication information can further comprise compensation information and compensation frequency information. The compensation information can compensate for a value transformed from a compensation frequency corresponding to the compensation frequency information in the combined sound file. The compensation frequency is within an audio frequency band (20-20,000 Hz).

The authentication information can comprise a serial number of the sound file playback device. Or, the authentication information can comprise one from a group consisting of numbers, letters and combinations thereof corresponding to identification information of the sound file playback device. The sound file playback device can be built in a mobile communication terminal, and the identification information can be a phone number or a mobile identification number (MIN) of the mobile communication terminal. In one embodiment, the combined frequency is outside an audio frequency band (20-20,000 Hz).

In one embodiment, the communication unit receives identification information and a request for assignment of authentication information from the sound file playback device. The authentication information registration unit assigns and registers authentication information corresponding to the identification information. The communication unit sends the assigned authentication information to the sound file playback device. The sound file playback device can receive and register the authentication information. The identification information can be a serial number of the sound file playback device. The sound file playback device can be built in a mobile communication terminal, and the identification information can be a phone number or an MIN (mobile identification number) of the mobile communication terminal.

Still another aspect of the present invention provides a sound file playback device playing back a sound file received from a sound file server. The sound file playback device can comprise: a communication unit, requesting the sound file server for the sound file and receiving the sound file; a frequency analyzing unit, analyzing the sound file received from the communication unit against a frequency domain and extracting a first authentication information; a comparison unit, comparing a second authentication information and the first authentication information, the second authentication information being registered in the sound file playback device; and a sound playback unit, playing back the sound file received from the communication unit in case the first authentication information and the second authentication information match as a result of comparison by the comparison unit.

In one embodiment, the communication unit sends identification information and a request for assignment of authentication information to the sound file server, and receives and registers the second authentication information and a combined frequency from the sound file server. The second authentication information is a code generated in the sound file server in accordance with the identification information, and the combined frequency is within a frequency band in which the second authentication information is located. The combined frequency is located outside an audio frequency band (20-20,000 Hz).

The sound file playback device can further comprise a compensation unit. The compensation unit extracts compensation information and compensation frequency information included in the first authentication information and applies a compensation value corresponding to the compensation information to a frequency band corresponding to the compensation frequency information in the sound file. The sound playback unit can play back a sound file in which the compensation value is applied. The frequency band corresponding to the compensation frequency information is within an audio frequency band.

In one embodiment, the first authentication information and second authentication information is a serial number of the sound file playback device. The first authentication information and second authentication information can be one from a group consisting of numbers, letters and combinations thereof corresponding to identification information of the sound file playback device. The sound file playback device can be built in a mobile communication terminal, and the identification information can be a phone number or an MIN of the mobile communication terminal.

Still another aspect of the present invention provides a method of providing a sound file capable of being played back in a sound file playback device with registered authentication information. The method can comprise: (a) receiving identification information and a request for a sound file from the sound file playback device, (b) determining whether authentication information corresponding to the identification information is registered, (c) extracting the authentication information if the authentication information is determined to be registered, (d) searching for the sound file requested in the step (a), (e) generating a combined sound file by including the authentication information extracted in the step (c) in a combined frequency and then combining the authentication information with the sound file searched for in the step (d) and (f) sending the combined sound file to the sound file playback device.

In one embodiment, the authentication information further comprises compensation information and compensation frequency information. The compensation information compensates for a value transformed from a compensation frequency corresponding to the compensation frequency information in the combined sound file. The compensation frequency is within an audio frequency band (20-20,000 Hz).

The step (a) follows: (A) receiving identification information and a request for assignment of authentication information from the sound file playback device; (B) assigning authentication information corresponding to the identification information; and (C) registering the authentication information and sending the authentication information to the sound file playback device. The sound file playback device can receive and register the authentication information. In one embodiment, the combined frequency is located outside an audio frequency band.

Yet another aspect of the present invention provides a method of playing back a sound file, received from a sound file server, in a sound file playback device. The sound file the method can comprise: (a) sending identification information and a request for a sound file to the sound file server, (b) receiving a combined sound file corresponding to the request for a sound file, (c) analyzing the combined sound file in a frequency domain, (d) extracting a first authentication information from the combined sound file analyzed in a frequency domain in the step (c), (e) comparing the first authentication information and second authentication information registered in the sound file playback device and (f) playing back the combined sound file in case the first authentication information and the second authentication information match as a result of the step (e).

The step (f) may further comprise: extracting compensation information and compensation frequency information included in the first authentication information; and applying a compensation value corresponding to the compensation information to a frequency band corresponding to the compensation frequency information in the combine sound file. The sound file playback device plays back a combined sound file to which the compensation value is applied. The frequency band corresponding to the compensation frequency information is within an audio frequency band.

The step (a) can follow: (A) sending the identification information and a request for assignment of authentication information to the sound file server, (B) receiving a second authentication information from the sound file server, wherein the sound file server assigns and registers the second authentication information corresponding to the identification information and (C) registering the second authentication information. In one embodiment, the combined frequency is located outside an audio frequency band.

Yet another aspect of the present invention provides a method of providing a sound file, comprising: receiving a request for a digital media file from a digital media reproducing device, obtaining i) the requested digital media file and ii) a code associated with the digital media reproducing device, combining the code and the requested digital media file, wherein the code is carried in a non-audio frequency and providing the combined file to the digital media reproducing device.

### BRIEF DESCRIPTION OF THE DRAWINGS

FIG. 1 shows a block diagram of a sound file server 100 in accordance with one embodiment of the present invention.

FIG. 2 shows the structure of a sound file playback device 200 in accordance with one embodiment of the present invention;

FIGS. 3a and 3b show flowcharts of a method for providing a sound file by the sound file server 100 in accordance with one embodiment of the present invention;

FIGS. 4a and 4b show flowcharts of a method for playing back a sound file in a sound file playback device 200 in accordance with one embodiment of the present invention;

FIG. 5 shows a method for providing and playing back a sound file by a sound file server 100 and a sound file playback device 200 in accordance with one embodiment of the present invention;

FIG. 6 shows a method for providing and playing back a sound file by a sound file server 100, a terminal 600 and a sound file playback device 200 in accordance with another embodiment of the present invention; and

FIGS. 7 and 8 are graphs showing frequency analysis of a combined sound file, to which authentication information is combined, in accordance with one embodiment of the present invention.

### DETAILED DESCRIPTION OF CERTAIN INVENTIVE EMBODIMENTS

Embodiments of the invention will be described with reference to the accompanying drawings. It shall be noted that the same elements are given the same reference numerals despite their appearance in different figure numbers. One embodiment of the present invention includes a sound file server and a sound file playback device. Hereinafter, a sound file server and a sound file playback device, as well as a method of providing a sound file and a method of playing back a sound file will be described.

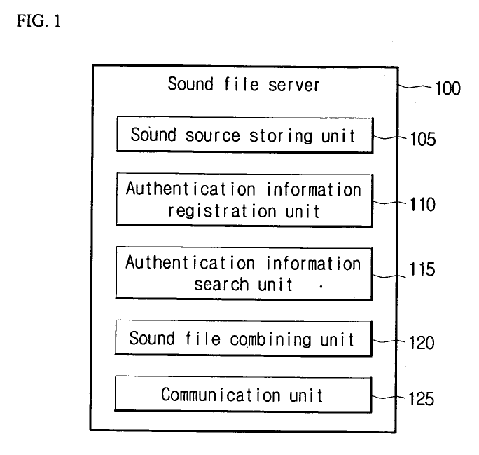

FIG. 1 shows a block diagram of a sound file server 100 in accordance with one embodiment of the present invention. The sound file server 100 comprises a sound source storing unit 105, an authentication information registration unit 110, an authentication information search unit 115, a sound file combining unit 120 and a communication unit 125.

The sound source storing unit 105 stores a plurality of sound files. The sound file may be an analog sound file or a digital sound file. In one embodiment, the sound file may be included in a non-sound file, for example, a motion picture file.

The authentication information registration unit 110 registers the authentication information, which will be described later, of a sound file playback device. The authentication information of a sound file playback device is for identifying the sound file playback device among a plurality of sound file playback devices that is currently requesting a specific sound file to the sound file server 100. In one embodiment, the authentication information is a code generated by the sound file server 100 or the serial number of the sound file playback device. The authentication information is registered in the authentication information registration unit 110 in accordance with the identification information of the sound file playback device. In another embodiment, the identification information of the sound file playback device is the user ID, the phone number of a mobile phone and the mobile identification number (MIN).

The authentication information search unit 115 searches the authentication information registration unit 110 for authentication information corresponding to the sound file playback device that is currently requesting a particular sound file to the sound file server 100. The authentication information is used to allow the sound file to be played back only in a sound file playback device that is registered in the sound file server 100.

The sound file combining unit 120 combines the authentication information to the sound file. The sound file requested by the sound file playback device is searched in the sound source storing unit 105. Then, the authentication information corresponding to the sound file playback device searched in the authentication information search unit 115 is loaded on a predetermined frequency. In other words, the authentication information is made to the predetermined frequency. In one embodiment, the frequency band for the authentication information is an inaudible frequency, which is outside the audio frequency of about 20 Hz-about 20,000 Hz (or humanly audible frequency). If the authentication information is included in the audible frequency, extracting the authentication information later in the sound file playback device becomes difficult. Besides, since it is highly possible that the authentication information becomes a noise during the playback of the sound file, the authentication information is included outside the audio frequency.

A combined sound file is created by combining the sound file searched from the sound source storing unit 105 and the authentication information included in the predetermined frequency. For the combination of the two signals, a synthesizer may be used.

The communication unit 125 receives a request for a particular sound file from the sound file playback unit, and then sends the combined sound file created by the sound file combining unit 120 to the sound file playback device, which requested the particular sound file. In case the combined sound file is an analog sound file, the communication unit 125 is a modulator, and the communication unit in the corresponding sound file playback unit is a demodulator. On the other hand, in case the combined sound file is a digital sound file, the communication unit 125 is an encoder, and the communication unit in the corresponding sound file playback unit is a decoder.

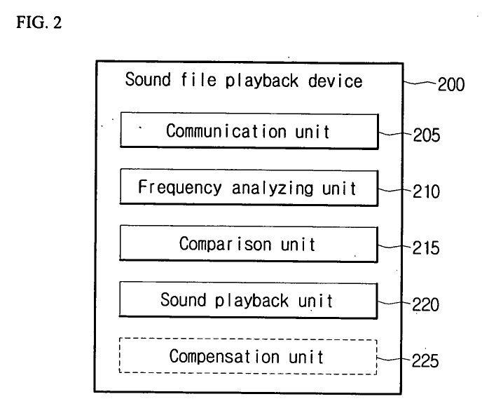

FIG. 2 shows the structure of a sound file playback device 200 in accordance with one embodiment of the present invention. The sound file playback device 200 comprises a communication unit 205, a frequency analyzing unit 210, a comparison unit 215 and a sound playback unit 220. If necessary, it can further comprise a compensation unit 225.

The communication unit 205 communicates with the sound file server 100. Through the communication unit 205, the sound file playback device 200 requests to the sound file server 100 for a sound source. Then, the communication unit 205 receives a combined sound file from the sound file server 100 as a response to the request.

The frequency analyzing unit 210 analyzes the combined sound file, received by the communication unit 205, in a frequency domain. The analysis in the frequency domain can be done using a variety of methods, including Fourier transform and Wavelet transform, which will be described later in detail. Based on the data analyzed in the frequency domain, a signal in the predetermined frequency band is detected. Here, the signal in the predetermined frequency band is the authentication information combined in the sound file server 100, and the predetermined frequency band is frequency band in which the frequency band is combined in the sound file server 100. In one embodiment, the sound file server 100 and sound file playback device 200 already have the frequency band information. Alternatively, the assigned frequency band may be notified with the authentication information to the sound file playback device 200 when the authentication information for each sound file playback device 200 is registered in the sound file server 100.

The frequency analyzing unit 210 analyzes the frequency of the combined sound file in order to extract the authentication information. In one embodiment, the frequency is analyzed as follows:

First, the Fourier transform is used as a general frequency analysis method. The Fourier transform uses the fact that any signal can be expressed as a sum of a plurality of signals, each of which has different level and frequency. When a signal having a time band on the x-axis and a level value on the y-axis in the time region is checked in the frequency domain, the signal has a frequency band in the x-axis and a level value on the y-axis. In other words, the frequency, constituting the signal, can be viewed based on the band. Using this, the sound file playback device 200 that already knows the frequency band, in which the authentication information is included, extracts the authentication information from the frequency band. This method checks every frequency band at regular intervals.

Second, the frequency is analyzed using a lookup table. A lookup table is information about a frequency band section of a sound signal that requires relatively higher resolving power. It includes information on the frequency section requiring relatively higher resolving power and the minimum resolving power required in the pertinent frequency section. For example, if the 40^{th} key of a C note and the 41^{st} key of a C# note in a keyboard instrument are to be identified, the frequency difference between the two notes is 15.557 Hz. Therefore, in one embodiment, the frequency is analyzed in a frequency interval that is smaller than 15.557 Hz near 261.626 Hz, which is the C note of the 40^{th} key, and 277.183 Hz, which is the C# note of the 41^{st} key. In other words, the resolving power in the section between 260 Hz and 280 Hz is approximately 15.557 Hz.

By using the lookup table that is created such that the resolving power becomes high near the frequency band in which the authentication information is included and low in the rest of the band, it becomes possible to analyze the frequency accurately faster than a general Fourier transform.

The look up table is shown below in Table 1:

TABLE 1

| frequency(Hz˜Hz) | range(Hz) | resolving power(Hz) | number of vectors |
|---|---|---|---|
| 200˜201 | 1 | 0.01 | 100 |
| 500˜500.1 | 0.1 | 0.001 | 100 |
| 10,000˜10,100 | 100 | 0.1 | 1000 |
| sum | | | 1200 |

Vectors are needed in order to transform the frequency for frequency analysis. The number of vectors is determined by the range of frequency transform and the frequency resolving power. For example, if the resolving power of 0.01 Hz is required in a frequency range of 100-110 Hz, the vectors of (110-100)/0.01 are needed. That is, 1,000 vectors are required.

The lookup table in Table 1 includes the information on the frequency section and the resolving power information. The frequency sections, which need to be analyzed, are 200-201 Hz for the first section, 500-500.1 Hz for the second section and 10,100 Hz for the third section. And the resolving powers are 0.01 Hz for the first section, 0.001 Hz for the second section and 0.1 Hz for the third section. In order to have the above resolving powers, the first section needs to have 100 vectors (i.e. (201-200)/0.01), the second section 100 vectors (i.e. (500.1-500)/0.001), and the third section 1,000 vectors (i.e. (10100-10000)/0.1). These vectors are used in the Fourier transform or the Wavelet transform. In one embodiment of the present invention, the above information on the frequency section for analysis becomes the information on the frequency band in which the authentication code is included outside the audio frequency band, and the above resolving power information becomes the resolving power for extracting the authentication code.

From the lookup table, the frequency section for analysis and the required number of vectors are calculated, and vectors corresponding to the above frequency section for analysis and the number of vectors needed are detected among the vectors that have been created and stored. Then, through the scalar product with a sound signal, the frequency analysis signal in the frequency section is generated.

Third, the frequency is analyzed using a bandpass filter. The bandpass filter is a filter that allows signals of a particular frequency band. Therefore, the bandpass filter can allow signals near the frequency band, in which the authentication information is included, to pass, and the authentication information is extracted using the output signal of the bandpass filter.

It should be evident to those skilled in the art that many other methods are possible.

The comparison unit 215 compares the authentication information, extracted by the frequency analyzing unit 210, and the authentication information, registered in the sound file playback device 200. In one embodiment, the authentication information, registered in the sound file playback device 200, is a code generated by the sound file server 100 and received and pre-stored by the sound file playback device 200. Or, it is preferable that the authentication information, registered in the sound file playback device 200, is the serial number of the sound file playback device 200.

The sound playback unit 220 either plays back or does not play back the received combined sound file, based on the result of the comparison by the comparison unit 215.

When the authentication information extracted by the frequency analyzing unit 210 and the authentication information registered in the sound file playback unit 200 match, the corresponding sound file playback device 200 is authenticated, thereby the sound file is played back. If, however, the authentication information extracted by the frequency analyzing unit 210 and the authentication information registered in the sound file playback unit 200 do not match, the received combined sound file must be protected, and thus the combined sound file is not played back or noise is generated.

When playing back the combined sound file, the authentication information included in the predetermined frequency band is removed before the playback is performed. Or, since the predetermined frequency band is outside the audio frequency, which is audible to human ear, the received combined sound file may be played back without removing the authentication information.

In another embodiment, the authentication information in the sound file server further comprises compensation information and compensation frequency information. In the case of a combined sound file, if the authentication information is included outside the audio frequency, the sound can be played back in most of the contemporary sound file playback devices (e.g. MP3 players, mobile phones with an MP3 player and terminals with an MP3 playback program). This is contrary to allowing the sound file to be played back only in playback devices that are authenticated.

Therefore, the signal value corresponding to a certain frequency band within audio frequencies, among the original sound files, is transformed according to certain rules. And compensation information is generated such that the transformation can be compensated later. The frequency band mentioned above becomes the compensation frequency. And as described above, a combined sound file is created by further adding the compensation information and compensation frequency information corresponding to the compensation frequency to the authentication information. Here, since the signal value of the combined sound file is transformed at the compensation frequency band within the audio frequency band, normal playback of the file is not possible.

As a method of transforming the signal value in accordance with the rule, the signal values corresponding to the compensation frequency are all made to 0 or to the maximum value, making the signal a noise. Or, a signal having a certain value is combined to the compensation frequency, creating a new combined sound file. Through this, the sound file playback device can not play back the sound normally without the compensation information, which is about what kind of transformation is made to the signal. If the sound file is played back without applying the compensation value from the compensation information, either noise is heard only, or certain frequency bands makes sound that is outside the normal frequency range, making a normal playback of the sound file impossible. Thus, the sound file can be only played back in a playback device that is authenticated.

The compensation information and compensation frequency band can be one or more pairs. By transforming multiple areas, which need restoration, to create combined sound files, the sound file can be securely protected.

In one embodiment, since the compensation frequency band is very narrow, the frequency is analyzed using the lookup table.

The sound file playback device 200 can further comprise the compensation unit 225. The compensation unit 225 detects the compensation information and compensation frequency information from the authentication information analyzed and extracted through the frequency analyzing unit 210. The compensation frequency band corresponding to the compensation frequency information is within the audio frequency.

From the received combined sound file, the signal value in the compensation frequency band is analyzed through frequency analysis. Then, using the detected compensation information, the signal value in the compensation frequency band is compensated to a normal value. Through this compensation, the combined sound file can be outputted as a normal sound. Without this compensation, the combined sound file is played back as is, and due to the uncompensated signal value, the sound is outputted as a noise or a discorded sound.

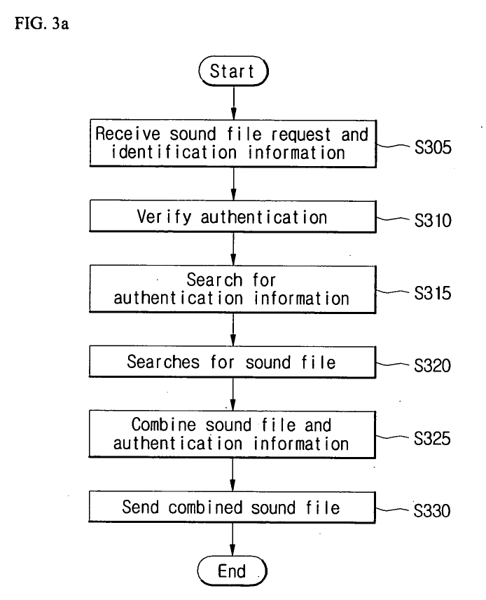

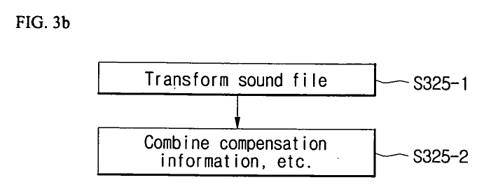

FIGS. 3a and 3b show flowcharts of a method for providing a sound file by the sound file server 100 in accordance with one embodiment of the present invention.

Referring to FIG. 3a, the method of providing a sound file by the sound file server 100 is as follows:

In step S305, the sound file server 100 receives a request for a sound file and identification information from the sound file playback device 200. Here, the sound file playback device 200 may be an MP3 player or a portable device, such as a mobile phone, with an MP3 player. The identification information is the user ID of the sound file playback device 200 or the phone number or the MIN of the mobile phone.

In step S310, the sound file server 100 verifies whether the sound file playback device 200, which requested the sound file in step S300, is a registered sound file playback device, based on the identification information. That is, it is verified whether the sound file playback device 200 has the authentication information registered in the authentication information registration unit 110 of the sound file server 100.

In step S315, the authentication information corresponding to the sound file playback device 200 is searched for through the authentication information search unit 115, in case the sound file playback device 200 is verified to have registered authentication information. This search is possible based on the identification information.

In step S320, the sound file server 100 searches the sound source storing unit 105 for the sound file that the sound file playback device 200 requested.

In step S325, the sound file server 100 combines the authentication information searched in step S315 to the searched sound file. Here, the authentication information is included in a frequency of the predetermined frequency band and is combined to the sound file. In one embodiment, the predetermined frequency band is outside the audio frequency.

In step S330, the sound file server 100 sends the sound file, created in step S325, to the sound file playback device 200, which requested the sound file.

Referring to FIG. 3b, the above step S325 further comprises the following steps:

In step S325-1, the sound file is transformed according to certain rules such that the signal value in a particular frequency band has another value other than the original value. And the compensation information, which can restore the original value from the transformation, is separately created. Then, the frequency band is included in the compensation frequency information. The rules have been already described in detail and thus will not be described herein.

In step S325-2, the authentication information is made to further comprise the compensation information and compensation frequency information, and is combined to the transformed sound file.

Through this, in case the combined sound file is played back in a device that is not authenticated, the compensation based on the compensation information can not be made, making normal playback of the sound file impossible. Therefore, the sound file can be played back only by the authenticated users.

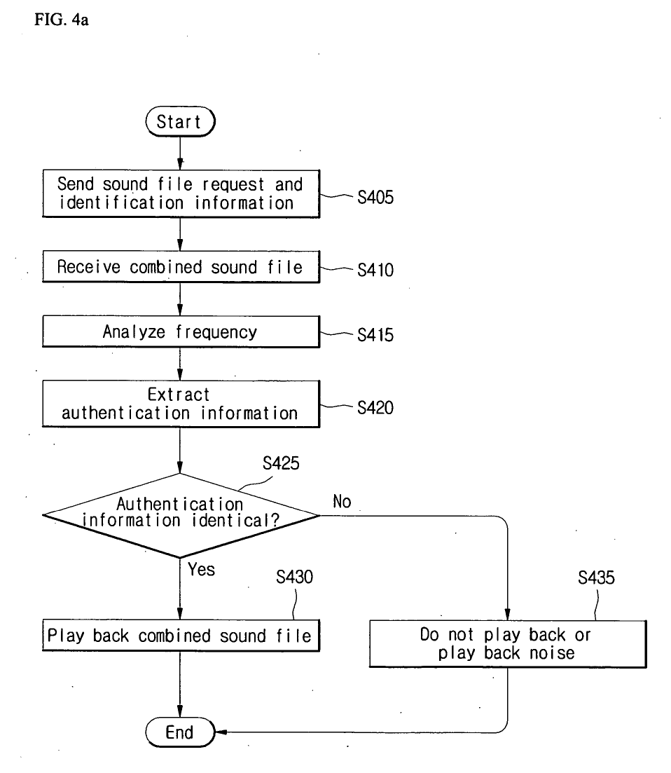

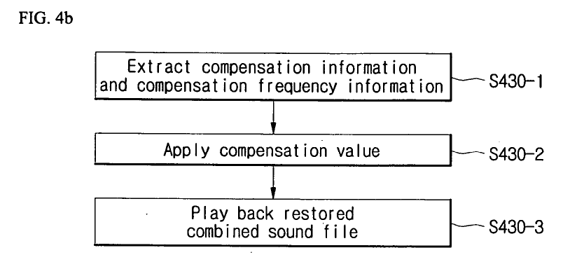

FIGS. 4a and 4b show flowcharts of a method of playing back a sound file in a sound file playback device 200.

Referring to FIG. 4a, the method for playing back a sound file in a sound file playback device 200 is as follows:

In step S405, the sound file playback device 200 requests to the sound file server 100 for a sound file. The request is made for a sound file or a plurality of sound files. When making the request, the sound file playback device 200 also sends identification information, which distinguishes it from other sound file playback devices.

In step S410, the sound file playback device 200 receives a combined sound file from the sound file server 100. Then in step S415, the received combined sound file is frequency-analyzed. Here, there can be a variety of methods for frequency analysis, including the Fourier transform method and the Wavelet transform method.

In step S420, the sound file playback device 200 extracts authentication information, i.e., a signal corresponding to a particular frequency band, from the frequency-analyzed combined sound file. The particular frequency band refers to a frequency band in which the authentication information is included and combined in the sound file server 100. In one embodiment, the particular frequency band is outside the audio frequency.

In step S425, the extracted authentication information and the authentication information registered in the sound file playback device 200 are compared. The authentication information registered in the sound file playback device 200 is a registered code, whose authentication information is assigned by the sound file server 100, prior to requesting for the sound file in step S405. Or, it is the serial number of the sound file playback device 200.

In step S425, if the comparison finds both of the authentication information identical, the authentication is successful. Then in step S430, the sound file playback device 200 plays back the sound file and outputs the sound file. The combined sound file may be played back with the authentication information. The authentication is placed outside the audio frequency band, and thus it is not audible. It is also possible to play back the combined sound file after removing the authentication information.

In step S425, if the comparison does not find both of the authentication information identical, the authentication fails, and thus step S435 is performed. The sound file playback device 200 either does not play back the combined sound file or plays back a noise.

Referring to FIG. 4b, step S430 comprises the following steps:

In step S430-1, the authentication information further comprises compensation information and compensation frequency information. That is, the combined sound file comprises a signal value, which is transformed, based on certain rules, in a compensation frequency band corresponding to the compensation frequency information. In one embodiment, in order to obtain normal output by compensating the transformed signal value, the compensation information and compensation frequency information is extracted.

In step S430-2, the normal signal value is restored by applying the compensation value, based on the above compensation information, in the compensation frequency band corresponding to the extracted compensation frequency information.

In step S430-3, the combined sound file, having the restored normal signal value, is played back and is outputted.

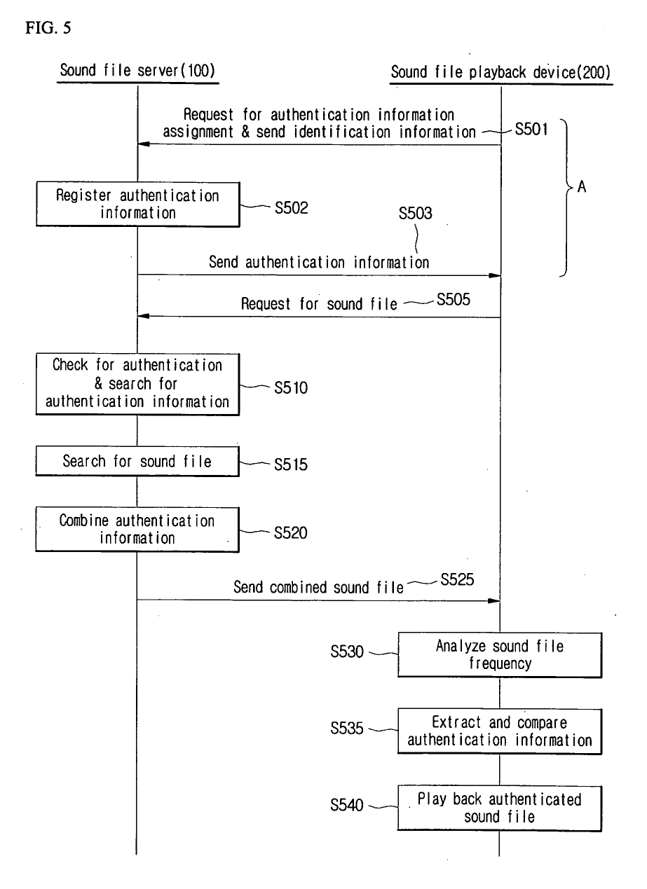

FIG. 5 shows a method for providing and playing back a sound file by a sound file server 100 and a sound file playback device 200.

Referring to FIG. 5, the sound file playback device 200 requests to the sound file server 100 for a sound file, in step S505. In step S510, the sound file server 100 determines whether the sound file playback device 200 is registered and checks for its authentication. If the device is registered, the corresponding authentication information is searched for. In step S515, the sound file requested by the sound file playback device 200 is searched for in the sound source storing unit 105, and in step S520, the sound file and authentication information are combined. As described above, the authentication information is included outside the audio frequency band and combined with the sound file.

In step S525, the sound file server 100 sends the combined sound file to the sound file playback device 200, and in steps S530 and S535, the sound file playback device 200 analyzes the frequency of the combined sound file, extracts the authentication information from the predetermined frequency band and compares this authentication information with the pre-registered authentication information. In step S540, if the comparison finds both of the authentication information identical, the sound file playback device 200 plays back and outputs the combined sound file. If, however, both of the authentication information is not identical, the sound file playback device 200 either does not play back the combined sound file or plays back a noise.

Here, the authentication information is different for each sound file playback device 200. The sound file server 100 generates authentication information for each sound file playback device 200 and assigns the authentication information in each sound file playback device 200. Or, the authentication information is generated based on the identification information received from each sound file playback device 200 and is assigned to each sound file playback device 200.

In steps S501 through S503, shown in section A of FIG. 5, the sound file playback device 200 sends the identification information of the sound file playback device 200 to the sound file server 100 while requesting for the assignment of authentication information, since the sound file playback device 200 will later request for a sound file to the sound file server 100. Here, the identification information is the serial number of the sound file playback device 200. Or, the identification information is the phone number or the MIN, in case the sound file playback device 200 is a mobile phone having an MP3 player.

The sound file server 100 assigns the authentication information based on the identification information received with the request for assignment of authentication information. Here, the authentication information can be numbers, letters or combinations thereof. The identification information itself can also be the authentication information.

After the authentication information is assigned, the authentication information is registered through the authentication information registration unit 100. Then, the sound file server 100 notifies the sound file playback device 200 that the authentication information has been assigned, and sends the assigned authentication information. The sound file playback device 200 registers the received authentication information. This authentication information is later used as a basis for comparison when the authentication is verified in step S535 after receiving the combined sound file.

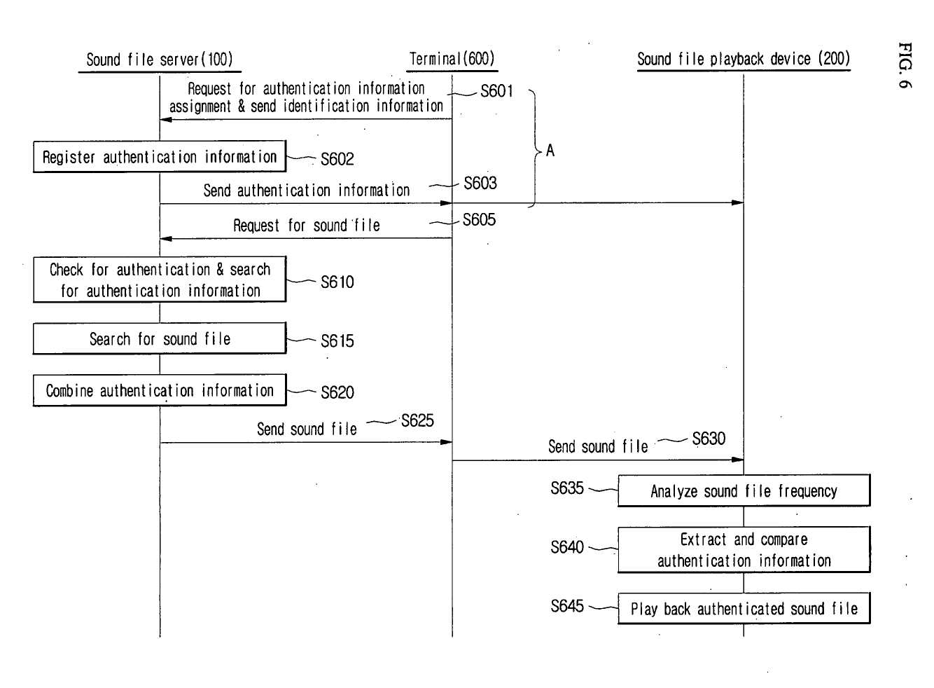

FIG. 6 shows a method for providing and playing back a sound file by a sound file server 100, a terminal 600 and a sound file playback device 200. The terminal 600 is, for example, a personal computer. The user registers, through the terminal 600, his/her sound file playback device 200 in the sound file server 100 and receives a sound file. The sound file playback device 200 then receives the sound file through the wire/wireless communication with the terminal 600.

Here, the authentication information is different for each sound file playback device 200. The sound file server 100 generates and assigns authentication information for each sound file playback device 200. Or, the sound file server 100 generates and assigns authentication information based on the identification information received from the terminal 600.

In steps S601 through S603, shown in section A of FIG. 6, the sound file playback device 200 plans to request the sound file server 100 for a sound file. Through the terminal 600, the user sends the identification information of the sound file playback device, in which the sound file is to be played back, and requests for the assignment of authentication information. The authentication information may be the serial number of the sound file playback device 200. Alternatively, the authentication information may be the phone number or the MIN in case the sound file playback device 200 is a mobile phone having an MP3 player.

The sound file server 100 assigns the authentication information based on the identification information received with the request for assignment of authentication information. The authentication information can be numbers, letters or combinations thereof. Alternatively, the identification information itself can be the authentication information.

After the authentication information is assigned, the authentication information is registered through the authentication information registration unit 100. Then, the sound file server 100 notifies the terminal 600 or the sound file playback device 200 that the authentication information has been assigned, and sends the assigned authentication information. In case the terminal 600 receives the authentication information, the authentication information is then sent to the sound file playback device 200. The sound file playback device 200 registers the received authentication information. This authentication information is later used as a basis for comparison when the authentication is verified in step S640 after receiving the combined sound file.

In step S605, a sound file is requested to the sound file server 100 through the terminal 600. Here, the terminal 600 also sends the identification information or authentication information of the sound file playback device 200, in which the sound file is to be played back. In step S610, the sound file server 100 determines whether the sound file playback device 200 is registered and checks for its authentication. If the device is registered, the corresponding authentication information is searched for. In step S615, the sound file requested by the terminal 600 is searched for in the sound source storing unit 105, and in step S620, the sound file and authentication information are combined. As described above, the authentication information is included outside the audio frequency band and combined with the sound file.

In step S625, the sound file server 100 sends the combined sound file to the terminal 600, and in step S630, the terminal 600 sends the combined sound file to the sound file playback device 200. In steps S635 and S640, the sound file playback device 200 analyzes the frequency of the combined sound file, extracts the authentication information from the predetermined frequency band and compares this authentication information with the pre-registered authentication information. In step S645, if the comparison finds both of the authentication information identical, the sound file playback device 200 plays back and outputs the combined sound file. If, however, both of the authentication information is not identical, the sound file playback device 200 either does not play back the combined sound file or plays back a noise.

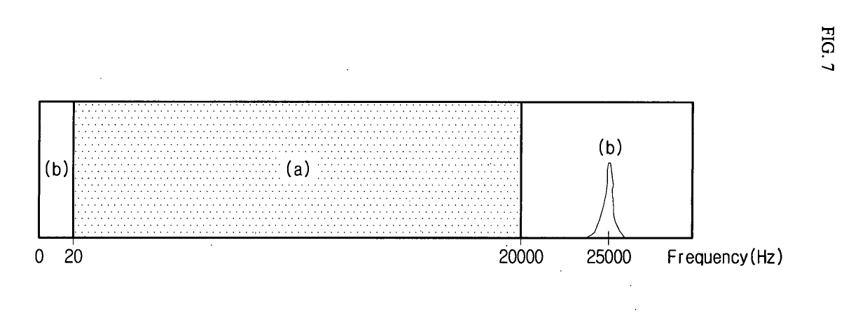

FIG. 7 is a graph showing frequency analysis of a combined sound file, to which authentication information is combined, in accordance with one embodiment of the present invention.

Referring to FIG. 7, the sound file has the audio frequency band (20-20,000 Hz, represented by (a)), which is audible to human ear. When the authentication information is to be combined with the sound file, in one embodiment, the authentication information is placed in the frequency band (b), which is outside the frequency band (a). By placing the authentication information in the frequency band (b), the authentication information can be easily identified without damaging the sound file.

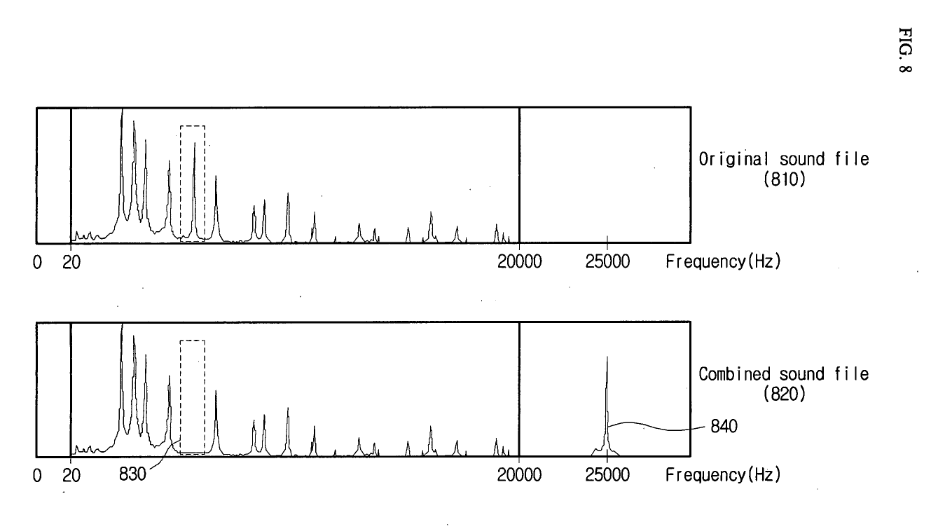

FIG. 8 is a graph showing frequency analysis of a combined sound file, to which authentication information is combined, in accordance with another embodiment of the present invention.

Referring to FIG. 8, the combined sound file 820 has a signal value that is transformed in a particular frequency band 830, when compared with the original sound file 810. In one embodiment, in order to output the same sound as the original sound file 810, the transformed signal value is compensated. This can be done through the use of the authentication information, compensation information and compensation frequency information, which are included in the combined frequency 840. The compensation information is placed in a predetermined frequency (25,000 Hz in FIG. 8) outside the audio frequency.

After determining, through the authentication information, whether the playback device is authenticated, a compensation value, with which the transformed signal value can be made identical to the original sound file 810, is obtained through the compensation information. And through the compensation frequency information, the compensation frequency band within the audio frequency, in which the transformed signal value is present, can be found.

In at least one embodiment, the sound file server and sound file playback device can include authentication information in a sound file such that only an authenticated user and an authenticated playback device can play back the sound file.

In addition, illegal copying and posting of a sound file can be prevented by preventing illegal distribution of the sound file, and real time authentication information can be inserted and extracted without affecting the sound quality.

Furthermore, the insertion/extraction operation of the authentication information can be processed real time and applied in a portable device such as an MP3 player. The authentication information can be inserted using a frequency range that is not audible to human ear.

In this manner a sound file can become a private property and the escrow service that changes authentication of the sound file in the Internet may be commenced by one embodiment of the present invention.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A system for providing a sound file, comprising:
a sound source storing unit configured to store a plurality of sound files;
an authentication information registration unit configured to store authentication information associated with a sound file playback device;
a communication unit configured to receive a request for a sound file from the sound file playback device; and
a sound file combining unit configured to i) obtain the requested file and corresponding authentication information from the sound source storing unit and the authentication information registration unit, respectively, and ii) generate a combined sound file including the obtained sound file and the authentication information in first and second frequency ranges, respectively, which are substantially different from each other
wherein the communication unit is further configured to send the combined sound file to the sound file playback device.

2. The system of claim 1, wherein:
the authentication information comprises compensation information and compensation frequency information, and
wherein the sound file combining unit is further configured to modify a portion of the sound file at a compensation frequency within the first frequency range such that the sound file playback device cannot reproduce the sound file without the compensation information.

3. The system of claim 2, wherein the first frequency range is from about 20 Hz to about 20,000 Hz.

4. The system of claim 1, wherein the authentication information comprises a serial number of the sound file playback device.

5. The system of claim 1, wherein:
the authentication information comprises at least one of the following: numbers, letters and codes configured to identify the sound file playback device.

6. The system of claim 1, wherein the second frequency range is located outside an audio frequency band.

7. The system of claim 1, wherein:
the communication unit is further configured to receive identification information, wherein the authentication information registration unit is further configured to stores the received identification information as authentication information, and wherein the communication unit is further configured to send the authentication information to the sound file playback device.

8. The system of claim 7, wherein the identification information is a serial number of the sound file playback device.

9. The system of claim 7, wherein the sound file playback device is embedded in a mobile communication terminal, and the identification information is a phone number or a mobile identification number (MIN) of the mobile communication terminal.

10. An apparatus for reproducing a sound file, comprising:
a communication unit configured to receive a sound file, wherein the sound file includes first authentication information;
a frequency analyzing unit configured to analyze the received sound file in a frequency domain and extract the first authentication information;
a comparison unit configured to compare previously stored second authentication information and the first authentication information; and
a sound playback unit configured to play back the received sound file upon matching of the first and second authentication information.

11. The apparatus of claim 10, wherein:
the communication unit is further configured to send identification information and a request for assigning authentication information to a sound file server, wherein the apparatus is configured to receive and store the received authentication information as the second authentication information.

12. The apparatus of claim 10, wherein the sound file further includes a sound data and the first authentication information carried in first and second frequency ranges, respectively, which are substantially different from each other.

13. The apparatus of claim 12, wherein the first authentication information includes compensation information and compensation frequency information, wherein a portion of the sound data is modified such that the reproducing apparatus cannot reproduce the received sound file without the compensation information, wherein the apparatus further comprises a compensation unit configured to reinstate the modified portion of the sound data based on the compensation information and compensation frequency information so that the entire sound data is reproduced.

14. The apparatus of claim 13, wherein the modified portion of the sound data is within an audio frequency band.

15. The apparatus of claim 10, wherein the first authentication information and second authentication information is an identification number of the reproducing apparatus.

16. The apparatus of claim 10, wherein:
the first and second authentication information is at least one of the following: numbers, letters and codes configured to identify the reproducing apparatus, and
wherein the reproducing apparatus is embedded in a mobile communication terminal, and the identification information is a phone number or a mobile identification number of the mobile communication terminal.

17. A method of providing a sound file, comprising:
receiving identification information and a request for a sound file from a sound file playback device;
extracting authentication information associated with the sound file playback device;
obtaining the requested sound file from previously stored plurality of sound files;
combining the obtained sound file and the authentication information so as to generate a combined sound file, wherein the authentication information is carried outside an audio frequency; and
sending the combined sound file to the sound file playback device.

18. The method of claim 17, further comprising:
modifying a portion of the sound file,
wherein the authentication information includes restoring information without which the sound file playback device cannot reproduce the sound file.

19. The method of claim 18, wherein the restoring information includes i) compensation information indicative of how the sound file has been modified and ii) compensation frequency information indicative of the frequency where the modified portion of the sound data is carried.

20. The system of claim 5, wherein the sound file playback device is embedded in a mobile communication terminal, and the identification information is a phone number or a mobile identification number of the mobile communication terminal.

21. The apparatus of claim 12, wherein the second frequency range is located outside an audio frequency band.

22. A method of reproducing a sound file, comprising:
receiving a sound file from a sound file server, wherein the sound file includes a sound data and first authentication information in first and second frequency ranges, respectively, which are substantially different from each other;
analyzing the received sound file in a frequency domain;
extracting the first authentication information from the sound file;
comparing the first authentication information and previously stored second authentication information; and
reproducing the sound data only if the first authentication information and the second authentication information match each other.

23. A method of claim 22, wherein the analyzing is performed by the use of at least one of the following: Fourier transform, a look-up table and a band pass filter.

24. The method of claim 22, wherein the second frequency range is outside an audio frequency band.

25. A method of providing a sound file, comprising:
receiving a request for a digital media file from a digital media reproducing device;
obtaining i) the requested digital media file and ii) a code associated with the digital media reproducing device;
combining the code and the requested digital media file, wherein the code is carried in a non-audio frequency; and
providing the combined file to the digital media reproducing device.

26. The method of claim 25, wherein the digital media file is a sound file.

27. The method of claim 25, wherein the digital media file includes a sound file and a non-sound file.

28. The method of claim 25, further comprising modifying a portion of the digital media file so that the digital media reproducing device cannot reproduce the media file without the code.

29. The method of claim 25, wherein the code includes identification information of the digital media reproducing device.

30. A system for providing a sound file, comprising:
means for receiving a request for a digital media file from a digital media reproducing device;
means for obtaining i) the requested digital media file and ii) a code associated with the digital media reproducing device;
means for combining the code and the requested digital media file, wherein the code is carried in a non-audio frequency; and
means for providing the combined file to the digital media reproducing device.
